(19) United States
(12) Patent Application Publication
(10) Pub. No.: US 2009/0286076 A1
(43) Pub. Date: Nov. 19, 2009

(54) Material to be measured for stress analysis, coating liquid for forming coating film layer on the material to be measured, and stress-induced luminescent structure

(76) Inventors: Chao-Nan Xu, Saga (JP); Yusuke Imai, Saga (JP); Nao Terasaki, Saga (JP); Yoshio Adachi, Saga (JP); Hiroshi Yamada, Saga (JP); Keiko Nishikubo, Saga (JP)

Correspondence Address: HARNESS, DICKEY & PIERCE, P.L.C., P.O. BOX 8910, RESTON, VA, 20195, US

(21) Appl. No.: 11/989,598

(22) PCT Filed: Aug. 2, 2006
(86) PCT No.: PCT/JP2006/315335

§ 371 Date: Jan. 29, 2008

(30) Foreign Application Priority Data
Aug. 3, 2005 (JP) 2005-226022

(51) Int. Cl. C09K 11/08; B32B 27/00

(52) U.S. Cl. 428/339; 252/301.36

(57) ABSTRACT

In one embodiment of the present invention, on the surface of a material to be measured for stress analysis which has a stress-induced luminescent material layer formed thereon, a distortion energy is disclosed which is transmitted from a base material of a stress-induced luminescent material to the stress-induced luminescent material with high efficiency. The material to be measured for stress analysis has, on the surface thereof, a coating film layer, which emits light upon exposure to a change in distortion energy. The coating film layer is formed of a synthetic resin layer containing stress-induced luminescent particles, and the modulus of elasticity of a base material is not less than 1.0 GPa. The thickness of the coating film layer is preferably 1 μm to 500 μm.

### TECHNICAL FIELD

The present invention relates to an analyte (material to be measured) for stress analysis, more specifically, to an analyte on which a coating film layer emitting light upon exposure to distortion energy is formed.

### BACKGROUND ART

For safety design, it is extremely important to perceive a stress state or a strain state of an object, which is caused when an impact or the like is applied to the object.

In recent years, various techniques to measure and analyze a stress and a strain of an object have been developed.

One of example methods is a stress measuring system which measures a stress applied on an object (analyte). In this system, a strain gauge is attached to the analyte, and the strain amount of the analyte is electrically detected. Thereby, the stress on the analyte is measured.

For measurement with the strain gauge, it is required to receive signals emitted by the strain gauge. Accordingly, it is required to arrange wiring means on the surface of the analyte.

Therefore, in a situation in which an analyte in fluid is to be measured or in the like situation, turbulent fluid is caused because of the wiring means or the like, and proper measurement cannot be performed.

In addition, the device of this configuration is complicated, and troubles are easily caused in this configuration depending on environment.

In view of this, a method for analyzing a stress of an analyte without wiring or the like has been provided.

More specifically, it is a method for measuring a stress distribution or the like of an analyte. A stress luminescent material (material having a stress luminescent function, which is formed of stress luminescent particles and a base material to be a matrix) is applied to the surface thereof, and a luminescence intensity of the stress luminescent material is measured, thereby measuring the stress distribution or the like on the analyte (see Patent Citation 1).

In this method, an electronic camera is arranged at a position corresponding to a position where the stress luminescence material is applied. Light emitted by the stress luminescent material is detected by this electronic camera and then analyzed.

Such analysis method using the stress luminescent material adopts a mechanism to directly detect the emission light, and only needs to apply the stress luminescent material as a device arranged on the surface of the analyte. So, it is extremely simple as a device.

Herewith, the device arranged on the surface of the analyte rarely has troubles.

The method in which light emitted by the stress luminescent material is detected by the electronic camera and then analyzed has been improved to a stress measuring system, which is used when a surface of an analyte has a complex shape such as a curved surface (three-dimensional shape).

However, in any of the above methods using the stress luminescent material, a stress luminescent material layer is formed on the surface of the analyte. Accordingly, when distortion energy is applied on the stress luminescent material layer itself along with the surface of the analyte, a force must be adequately transmitted from a base material forming the stress luminescent material layer (that is, a matrix) to stress luminescent particles.

If the force is not transmitted well, the distortion energy is eventually not transmitted to the stress luminescent particles. Thereby, light is not emitted or faintly emitted.

[Patent Citation 1] Japan Unexamined Patent Publication, Tokkukai, No. 2001-215157 (published on Aug. 10, 2001)

### DISCLOSURE OF INVENTION

### Problems To Be Solved By the Invention

The present invention is to solve the above problems.

That is, an object of the present invention is to achieve efficiently transmission of distortion energy from a base material of a stress luminescent material layer to stress luminescent particles on a surface of an analyte for stress analysis, on which the stress luminescent material layer (coating film layer) is formed.

### Means For Solving the Problems

As a result of a keen experiment and research in view of the above problems, the inventors of the present invention has found the following facts. That is, distortion energy transmission of the analyte to the stress luminescent material is dependent on modulus of elasticity of the base material itself, which forms the stress luminescent material layer. Herewith, the present invention is accomplished. In addition, generally, a base material to form the stress luminescent material with high modulus of elasticity is rarely used because of lack of transparency, and a base material which is strong and highly transparent, that is, a base material with low modulus of elasticity has been used. However, the inventors of the present invention has found the above property, and the present invention, which allows extremely successful light emission compared with the conventional stress luminescent material, is accomplished.

More specifically, (1) an analyte according to the present invention for stress analysis comprises: a coating film layer on a surface thereof, for emitting light upon exposure to a change of distortion energy, the coating film layer being formed of a synthetic resin layer including a base material and stress luminescent particles, the base material having modulus of elasticity of 1.0 GPa or above.

(2 The analyte according to the present invention as set forth in claim 1 may be arranged such that an optical transmittance per 100 μm of the synthetic resin layer is not less than 0.1%, but not more than 40%.

(3) The analyte of the present invention as set forth in above (1) or (2) may comprise a metal or synthetic resin material.

(4) The analyte of the present invention as set forth in above (1) or (2) may be an exterior or interior component of an automobile.

(5) The analyte of the present invention as set forth in above (1) or (2) may be an exterior or interior component of an aircraft.

(6) In the analyte of the present invention as set forth in above (1) or (2), the base material of the synthetic resin layer may be an epoxy resin or a urethane resin.

(7) In the analyte of the present invention as set forth in above (1) or (2), a parent material of the stress luminescent particle may be an oxide, a sulfide, a carbide, or a nitride having a stuffed tridymite structure, a three dimensional network structure, a feldspar structure, a wurtzite structure, a spinel structure, a corundum structure, or a β-almina structure.

(8) The analyte of the present invention as set forth in above (1) or (2) may be arranged such that the coating film layer has a film thickness in a range of from 1 μm to 500 μm.

(9) A coating liquid of the present invention is a coating liquid for forming the coating film layer as set forth in any one of above (1) through (8).

(10) In a stress luminescent structure of the present invention, the synthetic resin layer as set forth in above (1) or (2) is formed on a surface of a structural article.

(11) In the stress luminescent structure of the present invention as set forth in above (10), the structural object may be a building material, a material for experiment and research, a paper, or a card.

A configuration in proper combination with above (1) through (11) is also applicable, if it is along the above object of the present invention.

### Advantageous Effect of the Invention

An analyte for stress analysis has a coating film layer emitting light upon exposure to distortion energy on the surface thereof, so that the coating film layer is distorted along with the analyte and emits light.

The coating film layer is formed of a synthetic resin layer including a stress luminescent particle. The stress luminescent particle emits light.

Modulus of elasticity of a base material of the synthetic resin layer is 1.0 GPa or above. Herewith, the distortion energy is adequately transmitted from the analyte to the base material of the synthetic resin layer, and then to the stress luminescent particle. Herewith, the stress luminescent particle emits light.

### BRIEF DESCRIPTION OF DRAWINGS

FIG. 1(A) is a view schematically illustrating an aspect of stress transmission of the present invention. An analyte is under an unloaded condition where a force is not applied thereon.

FIG. 1(B) is a view schematically illustrating how stress transmission of the present invention occurs. Herein, a force is applied on the analyte, and the surface shape is deformed.

FIG. 2(A) is a view schematically illustrating how stress transmission of a conventional art occurs. Herein, an analyte is under an unloaded condition where a force is applied not thereon.

FIG. 2(B) is a view schematically illustrating an aspect of stress transmission of the present invention. Herein, a force is applied on the analyte, and the surface shape is deformed.

FIG. 3 is a view illustrating a relation between modulus of elasticity of a coating film layer and modulus of elasticity of a base material.

FIG. 4 is a view schematically illustrating an example of a stress measuring system for an analyte of the present invention.

### EXPLANATION OF REFERENTIAL NUMERALS

1: Coating Film Layer (Synthetic Resin Layer, Stress Luminescent Material Layer)

1A: Stress Luminescent Particle

1B: Base Material

2: Analyte

### BEST MODE FOR CARRYING OUT THE INVENTION

The present invention is aimed at forming a synthetic resin layer, which is a coating film layer, on a surface of an analyte in order to perform stress analysis (a state of a stress distribution and a strain state) of an analyte, which may be any object arbitrarily chosen.

When the synthetic resin layer is distorted along with the analyte, distortion energy is adequately transmitted from the analyte to a base material of the synthetic resin layer, and then to a stress luminescent particle. Herewith, the stress luminescent particle emits light.

By receiving and analyzing the light, various stress analysis (stress analysis, strain analysis or the like of the analyte) becomes possible.

### Analyte

As an analyte, various articles can be used, provided that it is an object for which stress analysis can be performed, that is, it is an object for stress analysis. The analyte is formed by a material such as a metal, a ceramic, a synthetic resin or the like.

More specifically, the analyte may be a component of a car body such as an exterior component (a bumper, a wheel, a body or the like), an internal component (a cylinder, a gear, and a cam) and the like. Also, an exterior and internal components of aircraft may be the analyte.

The analyte may be things practically used, or things experimentally used. That is, things on which an after-mentioned synthetic resin layer can be formed can be available.

### Synthetic Resin Layer

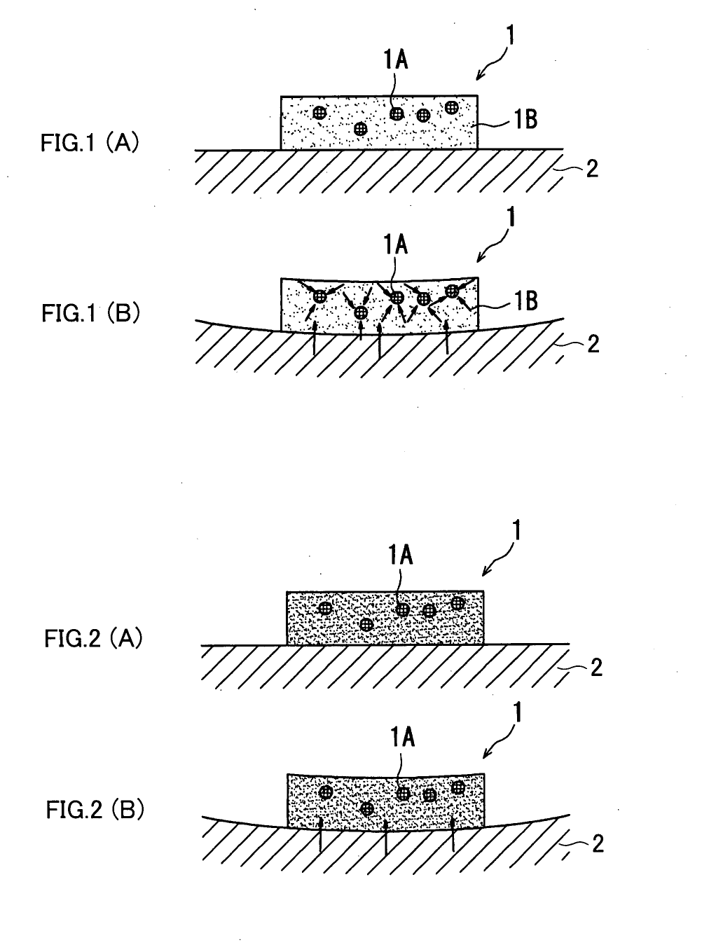

A synthetic resin layer 1 of the present invention includes a stress luminescent particle 1A and a base material 1B, and a given amount of the stress luminescent particle is contained in the base material (see FIG. 1). Put it differently, the synthetic resin layer 1 is a stress luminescent material including the stress luminescent particles 1A and the base material 1B.

In this case, the synthetic resin layer 1 is preferably formed in such a manner that the stress luminescent particle 1A is dispersed in the base material 1B as uniformly as possible.

The amount of the stress luminescent particle dispersed in the base material 1B is appropriately decided in accordance with usage of the analyte or a structural object, where the synthetic resin layer is formed on the surface. To 100 parts by weight of amount of the base material, the amount of the stress luminescent particle is preferably from 10 through 90 parts by weight, more preferably from 20 through 80 parts by weight, and further more preferably from 30 through 75 parts by weight. When the amount of the stress luminescent particle is from 10 through 80 parts by weight, enough amount of light emission is secured. Herewith, more successful light emission can be provided and a machine characteristic of the resultant synthetic resin layer is improved.

The synthetic resin layer 1 is formed on a surface of an analyte 2 as a layer having a certain thickness. The thickness, though it becomes different according to a form of the analyte 2, is preferably in a range of from 1 through 500 μm, and more preferably in a range of from 5 through 95 μm.

When the thickness is 1 μm or above, enough amount of the stress luminescent particle is included in the synthetic resin layer 1, so that enough luminescence intensity can be provided. When the thickness is 500 μm or below, alleviation of stress is reduced, so that enough luminescence intensity can be provided. Moreover, when the thickness is 5 μm or above, the amount of the stress luminescent particle contained therein increases, so that the better luminescence intensity can be attained. When the thickness is 95 μm or below, the alleviation of stress is reduced further, so that the much better luminescence intensity can be attained. Within the above range, the thicker the thickness of the synthetic resin layer 1 becomes, the better reproducibility and endurance are attained. For example, if experiments of forming the synthetic resin layer 1 on a stainless are repeatedly performed, the advantageous effect can be easily confirmed.

If the thickness of the synthetic resin layer is thin, the luminescence intensity increases according as the thickness becomes thicker.

This is because the amount of the luminescent particle increases according as the thickness of the synthetic resin layer becomes thicker.

On the contrary, when the film thickness is too thick, the luminescence intensity is saturated due to the thick thickness of the synthetic resin layer, because the synthetic resin layer is opaque.

On the other hand, according as the synthetic resin layer becomes thicker, the luminescence intensity decreases, because stress transmission is not fully performed according to alleviation of stress inside the layer.

The synthetic resin layer 1 is formed by applying a coating liquid to the analyte 2.

The coating liquid is formed by uniformly mixing: an epoxy resin or urethane resin which forms the base material of the synthetic resin layer; a curing agent and solvent for controlling cross-linkage and curing reaction of the resin; the stress luminescent particle; and a dispersant or auxiliary substance for uniformly dispersing the stress luminescent particle.

After applying the coating liquid, the base material is formed from the resin as a result of the curing and cross-linkage reaction thereof.

As a base material 1B of the synthetic resin layer 1, anything, which is adhesive onto the surface of the analyte 2, can be adopted. And also, provided that later-mentioned stress luminescent particle 1A can be strongly held and fixed, the base material 1B is not especially limited.

That is, the base material 1B, for example, may be a one-component or two-component curing type coating compound or adhesive is used, and more specifically, the base material 1B may be the epoxy resin, the urethane resin or the like.

The stress luminescent particle 1A to be included in the synthetic resin layer 1 may be prepared by adding a luminescence center in a parent material (for example, see Japan Unexamined Patent Publication, Tokukai, No. 2000-63824).

The parent material may be, for example, an oxide, a sulfide, a carbide, or a nitride having a stuffed tridymite structure, a three dimensional network structure, a feldspar structure, a crystal structure controlling lattice defect, a wurtzite structure, a spinel structure, a corundum structure, or a β-almina structure.

The luminescent center may be a rare-earth ion of Sc, Y, La, Ce, Pr, Nd, Pm, Sm, Eu, Gd, Tb, Dy, Ho, Er, Tm, Yb, and Lu, and a transition metal of Ti, Zr, V, Cr, Mn, Fe, Co, Ni, Cu, Zn, Nb, Mo, Ta and W.

When, for example, the parent material is a composite oxide including strontium and aluminum, it is preferable that the stress luminescent particle be xSrO.yAl₂O₃.zMO (M is a bivalent metal such as Mg, Ca, or Ba, and x, y and z are integral numbers, that is M is any bivalent metal but preferably Mg, Ca, or Ba, and x, y, and z are integral numbers not less than 1) or xSrO.yAl₂O₃.zSiO₂ (x, y, and z are integral numbers).

Above all, SrMgAl₁₀O₁₇:Eu, (SrₓBa₁₋ₓ)Al₂O₄:Eu (O<x<1), BaAl₂Si₂O₈:Eu, and the like are desirable.

Especially, α-SrAl₂O₄ structure including lattice defect is preferable.

A particle size of the stress luminescent particle 1A is not especially limited, provided that it is easy to be evenly dispersed in the base material 1B of the synthetic resin layer.

However, if the luminous intensity is measured with high resolution, it is better that the particle size is small, more specifically, an average particle size is preferably 50 μm or below.

It is more preferable that the average particle size be 5 μm or below.

### Principles

FIG. 1 are views schematically illustrating how the stress transmission of the present invention occurs.

Arrows indicates force application.

On the surface of the analyte, the synthetic resin layer 1 (including the base material 1B and the stress luminescent particle 1A) is formed.

The base material 1B of the synthetic resin layer 1 includes the stress luminescent particle 1A uniformly dispersed therein.

Assume that the analyte 2 is under an unloaded condition where a force is not applied thereon (FIG. 1(A)). When a force is applied on the analyte 2 and the surface thereof is deformed, distortion energy is transmitted from the base material 1B of the synthetic resin layer 1 to the stress luminescent particle 1A. Consequently, the stress luminescent particle 1A emits light (FIG. 1(B)).

In the present invention, modulus of elasticity of the base material 1B of the synthetic resin layer 1 is set to be 1.0 GPa or above, so that the force is transmitted from the analyte 2 to the base material 1B of the synthetic resin layer 1, and then surely transmitted from the base material 1B to the stress luminescent particle 1A.

Herewith, the stress luminescent particle 1A emits light.

Just for reference, FIG. 2 are views illustrating how stress transmission of a conventional art occurs wherein the modulus of elasticity of the base material is less than 1.0 GPa.

Even when a force is applied on the analyte 2 which is under an unloaded condition (FIG. 2(A)) and the surface shape is deformed, the distortion energy is not adequately transmitted from the base material 1B of the synthetic resin layer 1 to the stress luminescent particle 1A. Accordingly, the stress luminescent particle 1A does not emit light (FIG. 2(B)).

In the case where the modulus of elasticity of the base material 1B of the synthetic resin layer 1 is less than 1.0 GPa, even if the force is transmitted from the analyte 2 to the base material 1B of the synthetic resin layer 1, the force is not adequately transmitted to the stress luminescent particle 1A from the base material 1B.

Therefore, the stress luminescent particle 1A does not emit light, or faintly emit light, so that measurement analysis cannot be easily performed.

For reference, the following is a further explanation about this point.

When the coating film layer follows the deformation of the analyte, that is, the coating film layer and the analyte are distorted in a similar manner, generally, Equation 1 and Equation 2 are satisfied.

ε₁=ε₂ (Equation 1)

σ₁=(E₁/E₂)·σ₂ (Equation 2)

where the alphabets ε, σ, and E are a strain, a stress, and modulus of elasticity, respectively, and the subscripts 1 and 2 respectively mean the synthetic resin layer 1 and the analyte 2.

When a strain speed is constant, the luminous intensity is proportional to the stress. That is, according to Equation 2, the luminous intensity is proportional to the modulus of elasticity E₁ of the synthetic resin layer 1, which is a coating film layer.

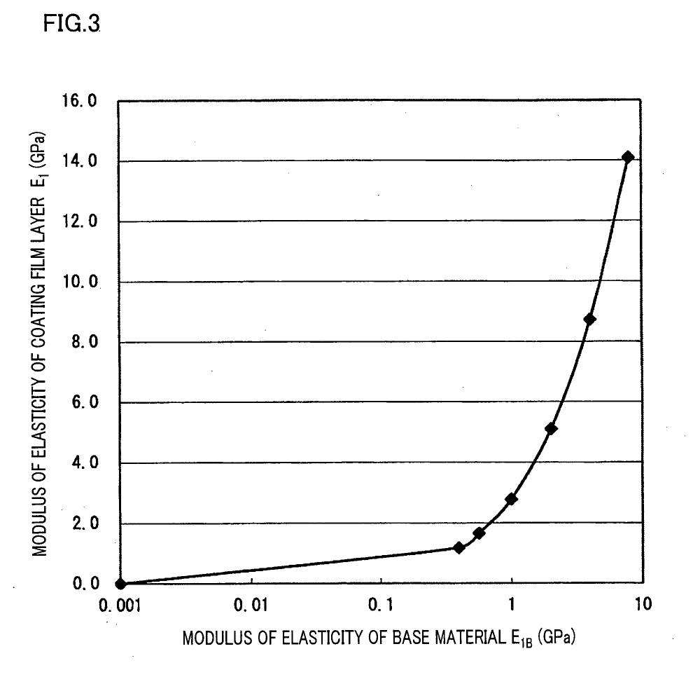

E₁ is a function of the modulus of elasticity E_{1B} of the base material 1B and the modulus of elasticity E_{1A} of the stress luminescent particle 1A. The proportion is illustrated in FIG. 3, in which a calculation is theoretically performed using the modulus of elasticity of SrAl₂O₄, which is 40 GPa (E_{1A}=40 GPa), as modulus of elasticity of the stress luminescent particle.

E₁ drastically increases at the point where the modulus of elasticity E_{1B} of the base material 1B exceeds 1.0 GPa.

Accordingly, the modulus of elasticity of the base material is preferably 1.0 GPa or above. More preferable modulus of elasticity is 2.0 GPa or above. When the base material with modules of elasticity of 1.0 GPa or above is used, it is possible to gain an analyte and a structural article having a synthetic resin layer on the surface thereof, the synthetic resin layer being excellent in distortion energy transmission.

The upper limit of the modulus of elasticity of the above base material is not especially limited, but is preferably 10 GPa or below. This makes it possible to easily form the synthetic resin layer of the present invention.

Incidentally, stress luminescent particles other than SrAl₂O₄ also shows a tendency similar to FIG. 3. The above explanation illustrates that E₁ drastically increases when E_{1B} is 1 GPa or above while E_{1A} is 40 GPa. However, at any given value E_{1A}, E_{1B} of 1 GPa or above increases E₁ drastically. Therefore, when modulus of elasticity of a base material is 1.0 GPa or above, a successful luminous intensity can be provided.

A transparency of the base material in accordance with the present invention is not limited, and whether it is transparent or opaque, either base material can be used.

The synthetic resin layer in accordance with the present invention, which is formed from the base material including the stress luminescent particle, for example, is not transparent in comparison with the stress luminescent material disclosed in Patent Citation 1. This is because the above amount of the stress luminescent particle is included in the base material. However, as described above, the synthetic resin layer in accordance with the present invention is excellent in distortion energy transmission. This makes it possible to provide an extremely successful luminous intensity, compared with the stress luminescent material disclosed in Patent Citation 1. An optical transmittance of the synthetic resin layer in accordance with the present invention is dependent on the amount of the stress luminescent particle, but the base material to be used for producing the synthetic resin layer, for example, is from 0.1 through 40% per 100 μm of the synthetic resin layer. The optical transmittance of the synthetic resin layer is more preferably from 0.1 through 30%. When the stress luminescent particle is included in such a manner that the optical transmittance of the synthetic resin layer is 40% or below, a successful luminescence can be provided. When the optical transmittance of the synthetic resin layer is 0.1% or above, the base material including the stress luminescent particle is sufficiently mixed. This allows a successful mechanical characteristic of the synthetic resin layer provided in such a way.

The optical transmittance of the coating film layer is not limited, but may be measured by a conventional method and device such as an absorption spectrometer or the like.

### Example of A Stress Measuring System Using An analyte)

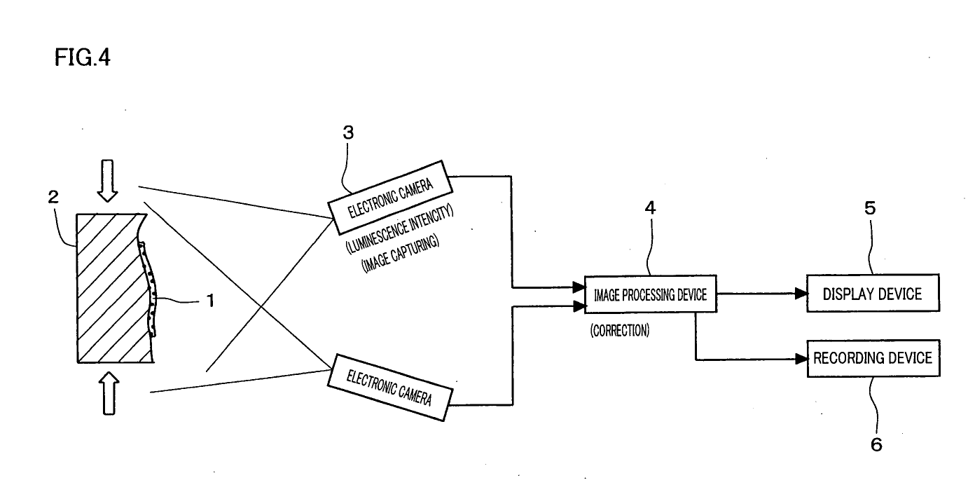

For references, FIG. 4 illustrates an example of a stress measuring system for an analyte in accordance with the present invention.

The stress measuring system in accordance with this embodiment includes: several image-capturing devices for detecting the luminous intensity and taking images of the shape of the analyte; and an image processing device for processing the luminous intensity and image information.

On the surface of the analyte 2, the synthetic resin layer 1 including the stress luminescent particle 1A, which is a stress luminescent material, is formed.

When a load is added on this analyte 2 and the analyte 2 is deformed, the synthetic resin layer 1 is also deformed along with the deformation. Then, the stress luminescent particle emits light according to the distortion energy, and the amount of this emitted light is measured.

More specifically, the light emitted by the stress luminescent material 1 is detected and measured by two electronic cameras 3, which are the image-capturing devices arranged to detect the luminous intensity of this stress luminescent particle 1A.

In this electronic camera 3, a collecting lens and an image pickup device are provided, and the light from the analyte 2 is collected by the collecting lens and received by the image pickup device.

In the image pickup device, photoelectronic conversion is processed. Output signals obtained via the photoelectronic conversion are converted to digital signals by an A/D converter, which is also provided in the electronic camera 3. In this way, the light intensity is detected.

These digital signals are input in an image processing device 4, for example, through a cable.

On the other hand, imaging information of the surface shape of the analyte 2 taken by two electronic cameras 3 are input in the image processing device 4.

In the image processing device 4, a three-dimensional shape of the analyte 2 is figured out based on the taken information.

Once the three-dimensional shape is figured out, a distance from each electronic camera 3 to a measurement point can be also calculated out. Herewith, corrections can be processed in consideration of the fact in which illumination intensity decreases according as the distance from a luminous source becomes further.

Consequently, a distribution of received light intensity from the image pickup device is corrected, whereby a stress distribution of the actual analyte can be calculated out in real time.

The three-dimensional shape of the analyte, for example, is calculated by a stereo method, a volume intersection method, an edge-based method, an isoluminance contour method or the like.

A three-dimensional stress distribution of the analyte 2, which is provided from the image processing device 4, is displayed by a display device 5, and a data of the three-dimensional stress distribution is recorded in a recording device 6.

In the recording device 6, for example, a hard disk is built in, and the data is recorded in the hard disk or a portable recording media such as a flexible disk, flash memory, or the like.

### A Structural Article Having A Synthetic Resin Layer On A Surface Thereof

As above, this embodiment of the present invention describes an embodiment of performing stress analysis using the synthetic resin layer in accordance with the present invention. However, the synthetic resin layer is not only applicable to the above analyte, but also can be applied to various structural articles, because the successful light emission can be provided.

A structural article, on a surface of which the synthetic resin layer is formed, is not limited, and the synthetic resin layer can be applied to various articles depending on purposes. Some examples of the structural article are a building material such as a beam, an armored concrete, a bolt, an iron bar and the like, and a material for experiment and research such as an artificial joint, various models. Not only to such a hard structural article, but also the synthetic resin layer can be preferably applied to a soft structural material such as a paper, a card or the like. When the synthetic resin layer is applied to such a soft structural object, it is preferable to be applied as thin as possible, and the thickness is preferably in a range of from 1 μm through 95 μm. This is because a bending stress added on the synthetic resin layer becomes lowered, and the endurance of the stress luminescent structural material is improved.

The following describes the present invention with examples, but the present invention is not limited to such examples.

### EXAMPLE 1

On a target surface of an analyte (stainless-steel), a synthetic resin layer in a rectangular shape (50 mm by 30 mm with 30 μm thickness) was formed.

A coating liquid, which was prepared in a paste form by mixing a base material and a stress luminescent particle, was applied to the target surface of the analyte in a layer form by spraying.

In this case, an epoxy resin was used as a base material of the synthetic resin layer (having modulus of elasticity of 1.5 GPa).

The coating liquid included an epoxy resin as a base material, an oleic acid as a dispersant, a higher alcohol and an aromatic hydrocarbon as a solvent, a polyamide-amine as a curing agent, and a compound of Sr_{0.09Al}₂O₄:Eu_{0.01} of 3 μm in particle size as a stress luminescent particle. Fifty percent by weight of the stress luminescent particle was included in the base material.

Under such conditions, the analyte was deformed by adding a load thereon, and light emitted by the stress luminescent particle was detected by electronic cameras.

An optical transmittance of the synthetic resin layer in accordance with Example 1 was 10%.

### EXAMPLE 2

As a base material, a urethane resin (having modulus of elasticity of 3.0 GPa) was used.

A coating liquid included an acrylic polyol which becomes the urethane resin, an ester and an aromatic hydrocarbon as a solvent, and an HMDI type polyisocynate as a curing agent. Other conditions are arranged in the same way as Example 1. Under such conditions, experiments were performed.

An optical transmittance of the synthetic resin layer in accordance with Example 2 was 1%.

### COMPARATIVE EXAMPLE 1

On a target surface of an analyte (stainless-steel), a synthetic resin layer in a rectangular shape (50 mm by 30 mm with 30 μm thickness) was formed.

A coating liquid, which was prepared in a paste form by mixing a base material and a stress luminescent particle, was applied to the target surface of the analyte in a layer form.

In this case, as a base material of the synthetic resin layer, a silicon resin (modulus of elasticity is 0.001 GPa) was used, and a compound of Sr_{0.09}Al₂O₄:Eu_{0.01} of 3 μm in its particle size was used as a stress luminescent particle. Fifty percent by weight of the stress luminescent particle was included in the base material.

Under such conditions, the analyte was deformed by adding a weight thereon, and light emitted by the stress luminescent particle was detected by electronic cameras.

An optical transmittance of the synthetic resin layer in accordance with Comparative Example 1 was 60%.

### COMPARATIVE EXAMPLE 2

A polyvinylidene chloride resin (modulus of elasticity is 0.4 GPa) was used as a base material, and other conditions were arranged in the same way as Comparative Example 2. Under such conditions, experiments were performed.

An optical transmittance of the synthetic resin layer in accordance with Comparative Example 2 was 50%.

### Evaluatuin

Luminescent intensities of the above examples and comparative examples are illustrated in Table 1.

It is appropriated that the modulus of elasticity of the base material in accordance with the synthetic resin layer of the present invention be arranged to be 1.0 GPa or above. From Table 1, the appropriateness will be understandable.

TABLE 1

| | LUMINESCENCE INTENSITY |
|---|---|
| | (RELATIVE VALUE*) |
| EXAMPLE 1 | 15,000 |
| EXAMPLE 2 | 36,000 |
| COMPARATIVE EXAMPLE 1 | 1 |
| COMPARATIVE EXAMPLE 2 | 110 |

*RELATIVE VALUE BASED ON EXAMPLE 1

### INDUSTRIAL APPLICABILITY

The present invention thus described above is not limited to such embodiments and concrete examples, but rather may be modified in various ways.

Needless to say, the analyte may be practical goods, apart from the analyte for stress analysis.

For example, if the coating liquid is applied to a wheel of a car, the coating film layer emits light upon exposure to a change of distortion energy while driving. Herewith, the application possibility is expanding from a viewpoint of decoration.

Specifically, other than an automobile or aircraft, it is natural that the present invention is applicable to various articles, too.

1. An analyte for stress analysis, the analyte comprising:
a coating film layer on a surface thereof, for emitting light upon exposure to a change of distortion energy,
the coating film layer being formed of a synthetic resin layer including a base material and stress luminescent particles, the base material having modulus of elasticity of 1.0 GPa or above.

2. The analyte as set forth in claim 1, wherein an optical transmittance per 100 μm of the synthetic resin layer is not less than 0.1%, but not more than 40%.

3. The analyte as set forth in claim 1, comprising a metal or synthetic resin material.

4. The analyte as set forth in claim 1, wherein the analyte is an exterior or interior component for an automobile.

5. The analyte as set forth in claim 1, wherein the analyte is an exterior or interior component for an aircraft.

6. The analyte as set forth in claim 1, wherein the base material of the synthetic resin layer is an epoxy resin or a urethane resin.

7. The analyte as set forth in claim 1, wherein a parent material of the stress luminescent particle is an oxide, a sulfide, a carbide, or a nitride having a stuffed tridymite structure, a three dimensional network structure, a feldspar structure, a wurtzite structure, a spinel structure, a corundum structure, or a β-almina structure.

8. The analyte as set forth in claim 1, wherein the coating film layer has a film thickness in a range of from 1 μm to 500 μm.

9. A coating liquid for forming the coating film layer recited in claim 1.

10. A stress luminescent structure, wherein the synthetic resin layer recited in claim 1 is formed on a surface of a structural article.

11. The stress luminescent structure as set forth in claim 10, wherein the structural article is a building material, a material for experiment and research, a paper, or a card.

12. The analyte as set forth in claim 2, comprising a metal or synthetic resin material.

13. The analyte as set forth in claim 2, wherein the analyte is an exterior or interior component for an automobile.

14. The analyte as set forth in claim 2, wherein the analyte is an exterior or interior component for an aircraft.

15. The analyte as set forth in claim 2, wherein the base material of the synthetic resin layer is an epoxy resin or a urethane resin.

16. The analyte as set forth in claim 2, wherein a parent material of the stress luminescent particle is an oxide, a sulfide, a carbide, or a nitride having a stuffed tridymite structure, a three dimensional network structure, a feldspar structure, a wurtzite structure, a spinel structure, a corundum structure, or a β-almina structure.

17. The analyte as set forth in claim 2, wherein the coating film layer has a film thickness in a range of from 1 μm to 500 μm.

18. A stress luminescent structure, wherein the synthetic resin, layer recited in claim 2 is formed on a surface of a structural article.
